(19) United States
(12) Patent Application Publication
(10) Pub. No.: US 2006/0231497 A1
(43) Pub. Date: Oct. 19, 2006

(54) Waste water treatment

(75) Inventor: Errol William O'Brien, MORAYFIELD (AU)

Correspondence Address: RODMAN RODMAN, 7 SOUTH BROADWAY, WHITE PLAINS, NY, 10601, US

(73) Assignee: BUSHWATER HOLDINGS PTY LTD., COOLUM BEACH (AU)

(21) Appl. No.: 10/564,759

(22) PCT Filed: Jul. 16, 2004
(86) PCT No.: PCT/AU04/00965

§ 371 Date: Jan. 13, 2006

(30) Foreign Application Priority Data
Jul. 16, 2003 (AU) 2003903646

(51) Int. Cl. C02F 1/52

(52) U.S. Cl. 210/721

(57) ABSTRACT

A process for treating waste water which contains soluble phosphorous, the process including the step of reacting the soluble phosphorous with a source of magnesium ions under reaction conditions to produce a phosphorous containing precipitate.

### FIELD OF THE INVENTION

The present invention relates to waste water treatment and, more particularly, to the treatment of waste water which contains soluble phosphorous.

### SUMMARY OF THE INVENTION

The present invention provides a process for treating waste water which contains soluble phosphorous, the process including the step of reacting the soluble phosphorous under reaction conditions to form a magnesium ammonium phosphate precipitate.

Preferably, the step of reacting the soluble phosphorous under reaction conditions includes the step of reacting the soluble phosphorous with a source of magnesium ions.

Preferably, the step of reacting the soluble phosphorous with a source of magnesium ions occurs in the presence of ammonium ions and dissolved oxygen.

Preferably, the precipitate is a complex known as struvite which has an assumed formula of MgNH₄PO₄.6H₂O.

Preferably, magnesium oxide provides a source of magnesium ions for reaction in the process. Preferably, the magnesium oxide is provided in the form of granules.

Preferably, the magnesium oxide granules are of a granular size in the order of 5-20 mm, more preferably, 10-20 mm.

Alternatively, the magnesium oxide may be provided in the form of a powder.

Preferably, the process is conducted in a reaction vessel containing a bed of the preferred magnesium oxide granules with the reaction vessel arranged for flow of the waste water through the bed. The waste water may flow through the bed in any direction but preferably flows either upwardly or downwardly through the bed.

Preferably, an oxygen containing gas is bubbled through the bed. Preferably, the gas is air.

Preferably, ammonia provides a source of ammonium ions for reaction in the process. Ammonia may be added as a reactant for the process; however, it is preferred that requisite ammonia is present in the waste water to be treated. Preferably, the waste water contains in excess of 20 ppm ammonia, more preferably in excess of 50 ppm ammonia, and most preferably about 50 ppm ammonia although the process can be satisfactorily conducted at ammonia levels below 20 ppm and above 50 ppm.

The waste water is preferably waste water from the treatment of sewerage. Sewerage waste water typically contains ammonia at a concentration in the order of 40-50 ppm following a typical secondary treatment of sewerage at large scale sewerage treatment plants. In some cases however, ammonia levels in sewerage waste water may be below 20 ppm. Although such waste water can be treated by the present invention, it is believed that additional ammonia would need to be added to the waste water to enable satisfactory production of the magnesium ammonium phosphate precipitate.

The process of the present invention is preferably conducted in a so-called home treatment plant (HTP) which may or may not be downstream of a septic treatment apparatus such as a septic tank. Waste water exiting septic tanks typically contains about 200 mg/L (ppm) ammonia, however, it still can be treated by the process of the present invention.

Phosphate may be removed from waste water treated in accordance with the present invention as a precipitate other than a magnesium ammonium phosphate precipitate. For example, operation of the process of the present invention may result in the formation of calcium hydroxy phosphate precipitates such as a complex known as hydroxy apatite which has an assumed formula of Ca₅OH(PO₄)₃. The formation of such precipitates additional to the preferred magnesium ammonium phosphate precipitates falls within the scope of the present invention with the production of such precipitates being dependent upon the specific composition of the waste water to be treated and the reaction conditions under which the process of the present invention is conducted. For example, the likelihood of producing hydroxy apatite will be enhanced where the waste water to be treated is hard, ie. contains a high level of calcium.

Waste water for treatment by the process of the present invention will typically contain in the order of 8-20 mg/L of phosphorous. It is preferable that the water following treatment in accordance with the present invention will contain less than 5 mg/L of phosphorous.

In one preferred embodiment of the present invention, a magnesium oxide bed is formed which is about 600 mm to 1200 mm deep, has a volume of about 20 litres, and is filled with magnesium oxide particles of 5-20 mm diameter to produce. a magnesium oxide bed having a mass of about 15 kg. The bed preferably forms part of a HTP with waste water entering the HTP having a phosphorous content in excess of 10 mg/L arranged to flow downwardly through the bed at a preferred flow rate of about 5-20 litres per minute, more preferably about 10-20 litres per minute. Waste water exiting the bottom of the bed has a phosphorous content less than 5 mg/L and typically has a pH between 8 and 9 although the bed is believed to have regions of higher localised pH (for example pH between 10 and 10.5).

In another preferred embodiment of the invention, magnesium oxide as a powder is added to raw liquid sewerage. This may occur in a sewerage treatment plant.

Preferably, the magnesium oxide powder is added at the inlet channel of the plant where the raw sewerage is well aerated.

Alternatively, the magnesium oxide powder may be added to the sewerage in an activated sludge tank, preferably towards the liquid inlet of the tank so as to facilitate mixing of the magnesium oxide with the sewerage.

Preferably, the magnesium oxide powder is added by a mechanical apparatus such as a screw or a vibratory powder feeder.

The present invention also provides a process for treating waste water which contains soluble phosphorous, the process including the step of reacting the soluble phosphorous with a source of magnesium ions under reaction conditions to produce a phosphorous containing precipitate.

The present invention further provides a treatment plant arranged to treat waste water containing soluble phosphorous from a residential property, the plant including means for reacting the soluble phosphorous with a source of magnesium ions under reaction conditions to produce a phosphorous containing precipitate.

### BRIEF DESCRIPTION OF THE DRAWINGS

A farther preferred embodiment of the invention will now be described, by way of example only, with reference to the accompanying drawings, in which:

FIG. 1 is a cut-away top view of a waste water treatment plant;

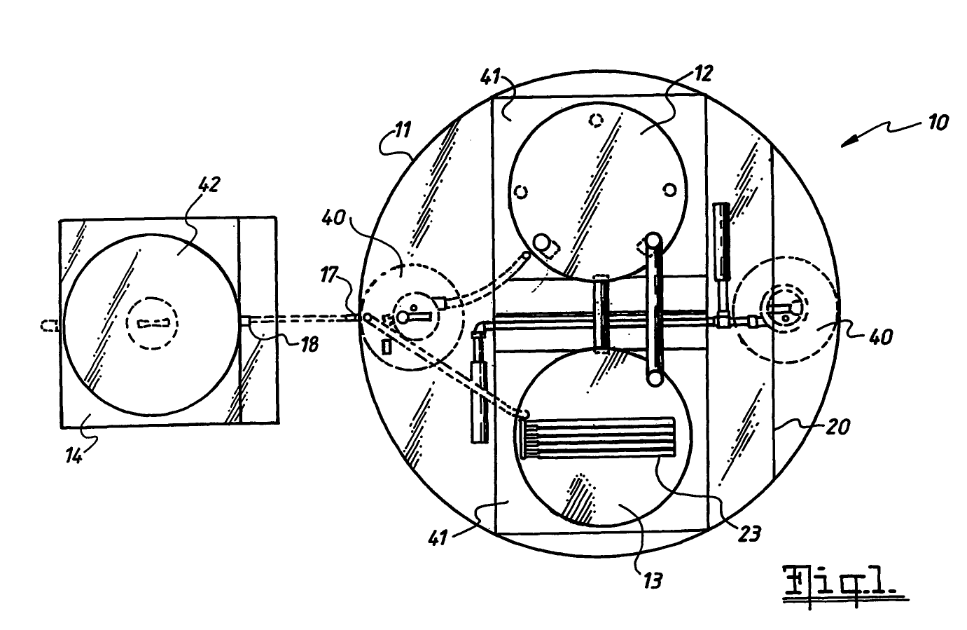

FIG. 2 is a side view of an activated sludge tank and an effluent reservoir tank of the waste water treatment plant of FIG. 1;

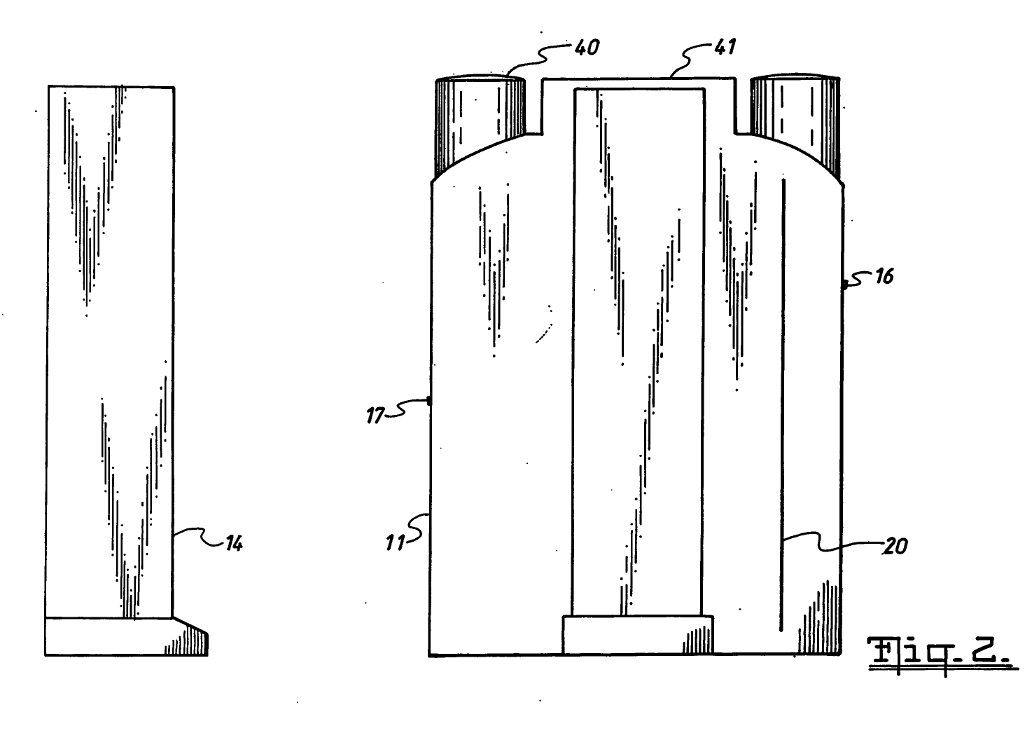

FIG. 3 is a partial side view of the waste water treatment plant of FIG. 1;

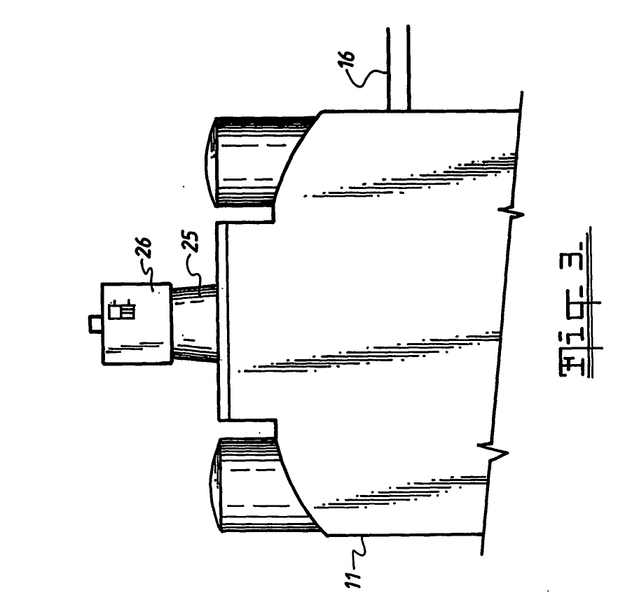

FIG. 4 is a side schematical view of the waste water plant of FIG. 1; and

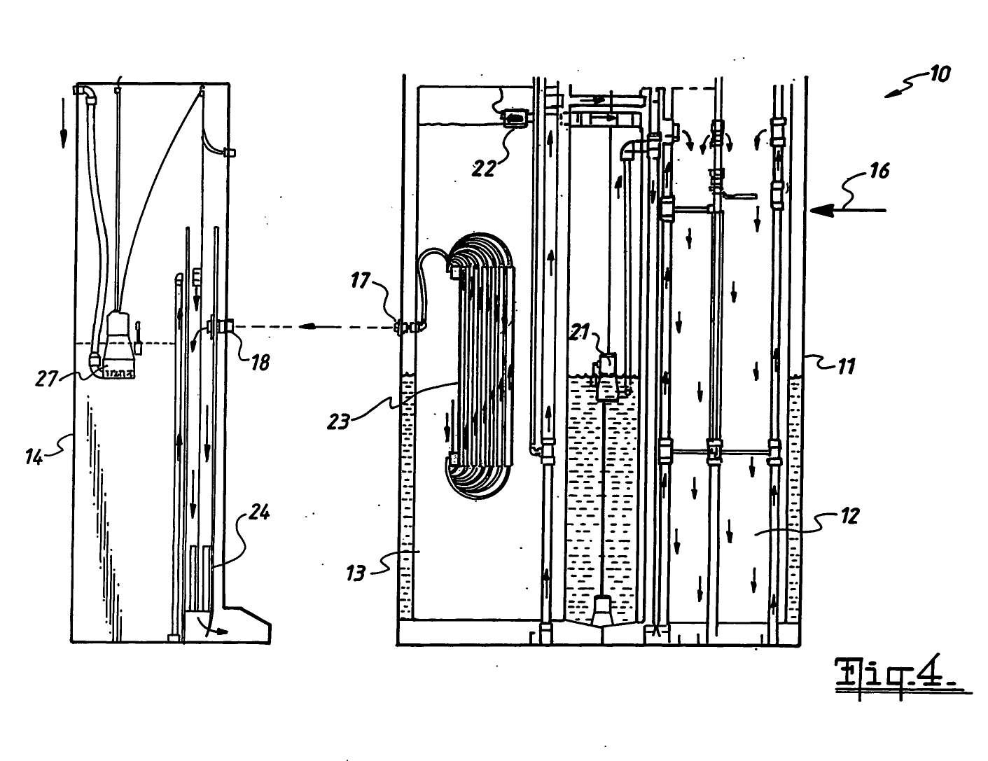

FIG. 5 is a schematic representation of an airlift pump.

### DETAILED DESCRIPTION OF A PREFERRED EMBODIMENT

Referring to the Figures, a waste water treatment plant 10, used to carry out a process according to preferred embodiments of the present invention, comprises an activated sludge tank 11, a mixed sludge reservoir tank 12, a bioreactor membrane treatment tank 13, and an effluent reservoir tank 14 located externally of the activated sludge tank 11. Tanks 12 and 13 are located within tank 11.

Tanks 11, 12, 13 and 14 are constructed of rotomouled polyethylene. The wall thickness of the activated sludge tank 11 and the effluent reservoir tank 14 is approximately 15 mm. The mixed sludge reservoir tank 12 and the bioreactor membrane treatment tank 13 have a wall thickness of approximately 10 mm. The activated sludge tank 11 has an outside diameter of about 2,040 mm and a total height of about 2,865 mm. Typically, installation of the activated sludge tank 11 involves burying the tank 11 in the ground with approximately 250 mm of the tank 11 exposed above ground.

Waste water is introduced into the side of the activated sludge tank 11 through inlet 16 which is located, in use, approximately 600 mm below ground level. A side baffle 20, inside the activated sludge tank 11, directs the flow of waste water to the bottom of the tank 11. Located between the baffle 20 and the inlet 16 of the activated sludge tank 11 is at least one (preferably four) beds of magnesium oxide granules (not shown). The bed(s) are contained in mesh holders. The waste water flows downwardly through the magnesium oxide bed(s) with struvite formed in the activated sludge tank 11 in accordance with the present invention with consequential reduction in phosphorous content in the activated sludge tank 11.

Within the activated sludge tank 11 there is a pump (not shown) that is used to drive venturi aeration to assist in the formation of struvite by increasing the levels of dissolved oxygen in the waste water. The waste water in the activated sludge tank 11 is circulated in one direction to aerate and to keep the sludge well mixed.

A pump 21 with a float switch, pumps the waste water which includes activated sludge from the activated sludge tank 11 into the mixed sludge reservoir tank 12. Airlift pumps constantly transport the waste water and sludge from the bottom of the mixed sludge reservoir tank 12 to the top, so as to maintain sufficient mixing.

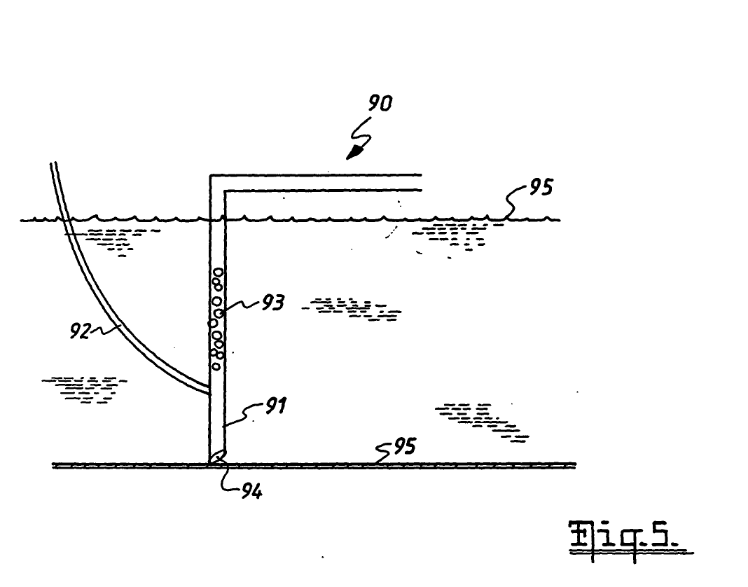

FIG. 5 shows a typical airlift pump 90, the airlift pump 90 consists of a narrow vertical tube, extending from the top 95 to the bottom 96 of the tank, with an opening 94 at the bottom of the tube 91. The opening 94 allows for the tube 91 to be filled with waste water. Air is supplied to the vertical tube 91 by means of an air supply line 92, which consequently lifts water and sludge as the bubbles of air 93 rise up the tube 91. Sludge and waste water is thus continuously recirculated back to the top of the mixed sludge reservoir tank 12.

A float switch 22 in the bioreactor membrane treatment tank 13 detects the level of waste water in the bioreactor membrane treatment tank 13 such that when the level is sufficiently low, waste water from the mixed sludge reservoir tank 12 is allowed to flow into the bioreactor membrane treatment tank 13.

The waste water is cleaned in the bioreactor membrane treatment tank 13, by passing it through a membrane pack 23. The membrane pack 23 has a capacity of approximately 1,776 litres/day. As the average raw inflow from a residential property is approximately 1,520 litres/day, the treatment plant 10 is suitable for use as a home treatment plant.

The membrane pack 23 is comprised of plates. Each plate has a left and right hand side member sheet and are 7 mm thick and set 7 mm apart. The membrane material can be a polyolefin or any other suitable material which is able to treat waste water, in particular raw sewerage.

An airblower 25 mounted on top of the activated sludge tank 11 blows air up through the membrane pack 23 in order to stop biological fouling. The airblower 25 is also used to drive the airlift pumps in the mixed sludge reservoir tank 12.

The treated effluent waste water flows from each membrane plate of the membrane pack 23 through outlet 17 and into the external effluent reservoir tank 14 through inlet 18 via a header pipe. Within the effluent reservoir tank 14 an electrochlorinator 24 provides electrolytic chlorination as a means of disinfection of the effluent to remove disease-causing bacteria.

An internal pump 27, with a float switch, within the effluent reservoir tank 14, pumps the treated effluent to irrigation or to storage for later use as required.

Solid waste from the influent waste water remains in suspension in the activated sludge tank 11, the mixed sludge reservoir tank 12 and the bioreactor membrane treatment tank 13. Over time, the level of solid waste or “sludge” inside these tanks 11, 12, 13 increases and thus desludging is required approximately every 3 to 6 years. Removal of accumulated sludge is achieved by pump-out from the activated sludge tank 11.

Access is provided to the inside of the tanks 11, 12, 13, 14 for maintenance, desludging and clearing of blockages via access hatches 40 to the raw inlet and to the activated sludge aeration area of the activated sludge tank 11, inspection hatches 41 to the mixed sludge reservoir tank 12 and the bioreactor membrane tank 13 and an access lid 42 to the effluent reservoir tank 14.

The treatment plant 10 has vented lids on the activated sludge tank 11, the mixed sludge reservoir tank 12 and the bioreactor membrane treatment tank 13 so that air may escape from these tanks. The access hatches 40 and inspection hatches 41 may act as the vented lids. The aeration of both inner and outer tanks 11, 12, 13 prevents the accumulation of foul air and gases within the tanks 11, 12, 13. In addition, a control box 26, located on top of the activated sludge tank 11. The control box 26 includes a fault alarm should safe pressure levels in the plant 10 be exceeded.

### EXAMPLE

A process according to a preferred embodiment of the present invention was used to treat raw sewerage. The treatment plant used was a Waterboy HSTP Model 10, which is designed to serve 10 persons. The treatment plant did not have an initial collection/septic tank. Instead, the raw sewerage flowed directly into the plant.

Sampling of the raw influent sewerage for the previous two years revealed that the sewerage had the following characteristics:

BOD 150-300 g/m³

Suspended solids 150-300 g/m³

Total nitrogen 20-100 g/m³

Total phosphorous 6-25 g/m³

Operation of the plant occurred over a period of 26 weeks (180 days), with testing periods in week 8, week 16 and week 26.

The following is a description of the operation schedule:

Week 1, Day 1

The flow in week 1 was set up at 190 litres per hour to run by timer from 6 am to 11 am and 6 pm to 9 pm each day.

Week 8, Day 49 to Day 53 (Testing Period 1)

The flow was adjusted to 225 litres per hour on day 49. On day 53, the plant flow rate was returned to 190 litres per hour to run by timer from 6 am to 11 am and 6 pm to 9 pm each day. Results from Testing Period 1 are shown in Table 1 below.

Week 16, Day 103 to Day 109 (Testing Period 2)

On day 103, the plant flow rate was adjusted to 225 litres per hour for the commencement of testing on day 106. On day 109, the flow rate was returned to 190 litres per hour to run by timer from 6 am to 11 am and 6 pm to 9 pm each day. The results from Testing Period 2 are contained in Table 2 below.

Week 17—Sludge Unloading and Reloading

The plant was shut down on day 110 and 800 litres of sludge was removed from the reaction section of the plant. Septic sludge was obtained from a septic unit and transported to the site. 800 litres of the septic sludge was pumped into the plant and allowed to settle for 24 hours. The plant was restarted on day 111 with a flow rate of 190 litres per hour to run by timer from 6 am to 11 am and 6 pm to 9 pm each day.

Week 26, Day 176 to Day 180 (Testing Period 3)

On day 176, the flow was adjusted to 225 litres per hour. On day 180, the flow was returned to 190 litres per hour. Results from Testing Period 3 are contained in Table 3 below.

During each testing day, the flow rate was adjusted to 300 litres per hour for 30 minutes prior to collecting samples for BOD, suspended solids, total faecal thermotolerant Coliforim, total nitrogen, phosphorous and chlorine levels were taken. Chlorine levels were tested and dissolved oxygen levels and temperatures were also evaluated using a DO meter.

Samples were taken prior to chlorine treatment for BOD and suspended solids and after chlorination for total faecal thermotolerant Coliform, chlorine, TKN and phosphorous.

The sampling was repeated after 60 and 90 minutes. After 120 minutes, the flow was adjusted to 600 litres per hour and sampled 30 minutes afterwards. After 150 minutes, the flow was returned to 225 litres per hour. This process was repeated for the following three days for the test periods.

Samples were tested by the Australian Laboratory Services, Brisbane Water and Caboolture Shire Council Water Testing Laboratories, which are both NATA registered laboratories. All samples were placed in ice in an esky immediately after sampling and delivered to the laboratory within two hours.

TABLE 1
Test Period 1 Results

| | | | | | | | | Total faecal | | | | |
|---|---|---|---|---|---|---|---|---|---|---|---|---|
| | Sample | | Flow | Total | | | | Coliform, | | | | Sample |
| Day | Number | Time | Rate | Nitrogen | Phosphorous | BOD | SS | CFU/100 ml | Dissolved O² | Temp. | Cl² | type |
| Day 50 | 1 | 6.30 am | 300 | 28.7 | 5.86 | 688 | 243 | | | 24° C. | — | Influent |
| | 2 | 7.00 am | 300 | 8.4 | 0.22 | 3 | 4 | <1 | 8.24 | 24° C. | 0.5 | Effluent |
| | 3 | 7.30 am | 305 | 8.6 | 0.22 | 2 | 3 | <1 | 8.2 | 24° C. | 0.5 | Effluent |
| | 4 | 8.00 am | 300 | 9.0 | 0.22 | 2 | 3 | <1 | 8.18 | 24° C. | 0.5 | Effluent |
| | 5 | 8.30 am | 600 | 8.7 | 0.22 | 2 | 2 | <1 | 8.21 | 24° C. | 0.5 | Effluent |
| | 6 | 9.00 am | 225 | 8.5 | 0.22 | — | — | <1 | 7.68 | 24° C. | 0.5 | Effluent |
| Day 51 | 1 | 6.30 am | 300 | 25.4 | 3.67 | 168 | 156 | | | 24° C. | — | Influent |
| | 2 | 7.00 am | 304 | 10.7 | 0.32 | 6 | <2 | <1 | 8.38 | 22.6° C. | 0.5 | Effluent |
| | 3 | 7.30 am | 302 | 9.9 | 0.32 | 3 | <2 | <1 | 8.27 | 23.2° C. | 0.5 | Effluent |
| | 4 | 8.00 am | 305 | 9.4 | 0.34 | 3 | <2 | <1 | 8.18 | 23.4° C. | 0.8 | Effluent |
| | 5 | 8.30 am | 610 | 10.8 | 0.38 | 2 | <2 | <1 | 8.17 | 24.2° C. | 0.8 | Effluent |
| | 6 | 9.00 am | 225 | 9.8 | 0.54 | — | — | <1 | 7.86 | 24.6° C. | 0.8 | Effluent |
| Day 52 | 1 | 6.30 am | 300 | 68.1 | 14.23 | 335 | 414 | | | 24° C. | | Influent |
| | 2 | 7.00 am | 302 | 11.7 | 0.52 | 5 | <2 | <1 | 8.37 | 24° C. | 1.8 | Effluent |
| | 3 | 7.30 am | 310 | 11.0 | 0.54 | <3 | <2 | <1 | 8.3 | 24° C. | 1.6 | Effluent |
| | 4 | 8.00 am | 306 | 10.1 | 0.56 | <3 | <2 | <1 | 8.12 | 24.1° C. | 1.5 | Effluent |
| | 5 | 8.30 am | 600 | 9.7 | 0.56 | <3 | <2 | <1 | 8.07 | 24° C. | 1.5 | Effluent |
| | 6 | 9.00 am | 225 | 8.3 | 1.34 | — | — | <1 | 7.38 | 24.3° C. | 1.5 | Effluent |
| Day 53 | 1 | 6.30 am | 300 | 57.0 | 10.6 | 593 | 307 | — | | 24° C. | | Influent |
| | 2 | 7.00 am | 305 | 7.2 | <0.05 | <3 | <2 | <1 | 8.2 | 24° C. | 1.7 | Effluent |
| | 3 | 7.30 am | 308 | 8.0 | <0.05 | <3 | <2 | <1 | 8.27 | 24.2° C. | 1.0 | Effluent |
| | 4 | 8.00 am | 310 | 7.3 | 0.5 | <3 | <2 | <1 | 8.18 | 24.3° C. | 1.0 | Effluent |
| | 5 | 8.30 am | 612 | 7.8 | <0.05 | <3 | <2 | <1 | 8.05 | 24.3° C. | 1.2 | Effluent |
| | 6 | 9.00 am | 190 | 6.6 | 0.62 | — | — | <1 | 7.78 | 24.4° C. | 0.8 | Effluent |

TABLE 2
Test Period 2 Results

| | | | | | | | | Total faecal | | | | |
|---|---|---|---|---|---|---|---|---|---|---|---|---|
| | Sample | | Flow | Total | | | | Coliform, | | | | Sample |
| Day | Number | Time | Rate | Nitrogen | Phosphorous | BOD | SS | CFU/100 ml | Dissolved O² | Temp. | Cl² | type |
| Day 106 | 1 | 6.30 am | 300 | 105 | 47.6 | 1200 | 2167 | | | 27° C. | — | Influent |
| | 2 | 7.00 am | 300 | 6.9 | 3.01 | <3 | 12 | <1 | 8.4 | 25.2° C. | 2.0 | Effluent |
| | 3 | 7.30 am | 305 | 6.3 | 2.98 | <3 | <2 | <1 | 8.4 | 25.1° C. | 2.0 | Effluent |
| | 4 | 8.00 am | 300 | 5.9 | 3.04 | <3 | 12 | <1 | 8.1 | 25° C. | 1.8 | Effluent |
| | 5 | 8.30 am | 600 | 6.4 | 3 | <3 | <2 | <1 | 8.0 | 25.1° C. | 1.8 | Effluent |
| | 6 | 9.00 am | 225 | 5.9 | 2.86 | <3 | 3 | <1 | 7.8 | 26.1° C. | 1.8 | Effluent |
| Day 107 | 1 | 6.30 am | 300 | 65 | 18.05 | 375 | 682 | | | 27° C. | — | Influent |
| | 2 | 7.00 am | 304 | 5.0 | 3.1 | <3 | <2 | <1 | 8.46 | 25.8° C. | 1.0 | Effluent |
| | 3 | 7.30 am | 302 | 4.4 | 3.28 | <3 | <2 | <1 | 8.1 | 25.8° C. | 0.8 | Effluent |
| | 4 | 8.00 am | 305 | 3.3 | 3.05 | <3 | <2 | <1 | 7.5 | 25.9° C. | 0.8 | Effluent |
| | 5 | 8.30 am | 610 | 3.9 | 2.91 | <3 | <2 | <1 | 7.4 | 25.9° C. | 0.8 | Effluent |
| | 6 | 9.00 am | 225 | 4.3 | 2.79 | <3 | <2 | <1 | 5.4 | 25.9° C. | 0.8 | Effluent |
| Day 108 | 1 | 6.30 am | 300 | 52.8 | 11.97 | 200 | 255 | | | 27.5° C. | | Influent |
| | 2 | 7.00 am | 302 | 6.7 | 3.57 | <3 | <2 | <1 | 8.1 | 26.9° C. | 1.0 | Effluent |
| | 3 | 7.30 am | 310 | 5.7 | 3.6 | <3 | 6 | <1 | 8.1 | 26.9° C. | 0.8 | Effluent |
| | 4 | 8.00 am | 306 | 5.9 | 3.54 | <3 | <2 | <1 | 8.0 | 26.9° C. | 0.8 | Effluent |
| | 5 | 8.30 am | 600 | 5.9 | 3.52 | <3 | <2 | <1 | 7.6 | 27° C. | 0.7 | Effluent |
| | 6 | 9.00 am | 225 | 5.2 | 3.08 | <3 | 6 | <1 | 5.48 | 27.2° C. | 0.5 | Effluent |
| Day 109 | 1 | 6.30 am | 300 | 42.2 | 9.42 | 175 | 134 | — | | 27° C. | | Influent |
| | 2 | 7.00 am | 305 | 4.5 | 4.63 | <3 | <2 | <1 | 8.3 | 26.9° C. | 0.5 | Effluent |
| | 3 | 7.30 am | 308 | 3.5 | 4.66 | <3 | <2 | <1 | 6.8 | 26.9° C. | 0.7 | Effluent |
| | 4 | 8.00 am | 310 | 3.1 | 4.54 | <3 | <2 | <1 | 7.1 | 27.0° C. | 0.8 | Effluent |
| | 5 | 8.30 am | 612 | 4.6 | 4.54 | <3 | <2 | <1 | 7.0 | 27.6° C. | 0.8 | Effluent |
| | 6 | 9.00 am | 190 | 4.7 | 4.5 | <3 | <2 | <1 | 5.6 | 26.9° C. | 0.6 | Effluent |

TABLE 3
Test Period 3 Results

| | | | | | | | | Total faecal | | | | |
|---|---|---|---|---|---|---|---|---|---|---|---|---|
| | Sample | | Flow | Total | | | | Coliform, | | | | Sample |
| Day | Number | Time | Rate | Nitrogen | Phosphorous | BOD | SS | CFU/100 ml | Dissolved O² | Temp. | Cl² | type |
| Day 177 | 6 | 6.30 am | 300 | 31.7 | 6.03 | 113 | 140 | | | 30° C. | — | Influent |
| | 1 | 7.00 am | 300 | 4.6 | 0.23 | <5 | 5 | <1 | 5.8 | 30° C. | 0.5 | Effluent |
| | 2 | 7.30 am | 305 | 4.6 | 0.21 | <5 | 2 | <1 | 5.7 | 30° C. | 0.5 | Effluent |
| | 3 | 8.00 am | 300 | 3.8 | 0.2 | <5 | 3 | <1 | 5.8 | 29.9° C. | 0.5 | Effluent |
| | 4 | 8.30 am | 600 | 3.4 | 0.18 | <5 | <2 | <1 | 6.64 | 29.9° C. | 0.5 | Effluent |
| | 5 | 9.00 am | 225 | 5.6 | 0.16 | <5 | <2 | <1 | 5.9 | 30.2° C. | 0.6 | Effluent |
| Day 178 | 6 | 6.30 am | 300 | 31.1 | 4.67 | 127 | 181 | | | 31° C. | — | Influent |
| | 1 | 7.00 am | 304 | 7.7 | 0.16 | <5 | <2 | <1 | 5.6 | 30° C. | 0.5 | Effluent |
| | 2 | 7.30 am | 302 | 6.9 | 0.14 | <5 | <2 | <1 | 4.9 | 30.2° C. | 0.4 | Effluent |
| | 3 | 8.00 am | 305 | 4.7 | 0.12 | <5 | <2 | <1 | 5.45 | 30.2° C. | 0.5 | Effluent |
| | 4 | 8.30 am | 610 | 3.5 | 0.09 | <5 | <2 | <1 | 5.6 | 30.2° C. | 0.5 | Effluent |
| | 5 | 9.00 am | 225 | 5.6 | 0.12 | <5 | <2 | <1 | 5.4 | 30.4° C. | 0.5 | Effluent |
| Day 179 | 6 | 6.30 am | 300 | 29.8 | 4.15 | 69 | 248 | | | 29.8° C. | | Influent |
| | 1 | 7.00 am | 302 | 6.7 | 0.19 | <5 | <2 | <1 | 5.8 | 30° C. | 1.8 | Effluent |
| | 2 | 7.30 am | 310 | 5.7 | 0.21 | <5 | <2 | <1 | 5.3 | 30.3° C. | 1.8 | Effluent |
| | 3 | 8.00 am | 306 | 5.7 | 0.17 | <5 | <2 | <1 | 5.5 | 29.8° C. | 1.5 | Effluent |
| | 4 | 8.30 am | 600 | 5.0 | 0.17 | <5 | <2 | <1 | 5.2 | 29.8° C. | 1.5 | Effluent |
| | 5 | 9.00 am | 225 | 4.7 | 0.16 | <5 | <2 | <1 | 4.8 | 29.8° C. | 1.5 | Effluent |
| Day 180 | 6 | 6.30 am | 300 | 26.5 | 4.37 | 95 | 272 | — | | 30.2° C. | | Influent |
| | 1 | 7.00 am | 305 | 3.4 | 0.2 | <5 | <2 | <1 | 5.7 | 30.1° C. | 0.5 | Effluent |
| | 2 | 7.30 am | 308 | 3.9 | 0.19 | <5 | <2 | <1 | 5.8 | 30.1° C. | 0.5 | Effluent |
| | 3 | 8.00 am | 310 | 3.7 | 0.19 | <5 | <2 | <1 | 5.8 | 30.1° C. | 0.5 | Effluent |
| | 4 | 8.30 am | 612 | 3.3 | 0.17 | <5 | <2 | <1 | 5.6 | 30.1° C. | 0.5 | Effluent |
| | 5 | 9.00 am | 190 | 3.1 | 0.16 | <5 | <2 | <1 | 4.7 | 30.2° C. | 0.5 | Effluent |

In the claims which follow and in the preceding description of the invention, except where the context requires otherwise due to express language or necessary implication, the word “comprise” or variations such as “comprises” or “comprising” is used in an inclusive sense, ie. to specify the presence of the stated features but not to preclude the presence or addition of further features in various embodiments of the invention.

1. A process for treating waste water which contains soluble phosphorous and which comprises a solid component and a liquid component, the process including the step of reacting soluble phosphorous from the solid and liquid components with a source of magnesium ions under reaction conditions to produce a phosphorous containing precipitate.

2. A process for treating waste water which contains soluble phosphorous, the process including the step of reacting the soluble phosphorous with a source of magnesium ions in the presence of greater than 20 ppm ammonia under reaction conditions to produce a phosphorous containing precipitate.

3. A process as claimed in claim 1 wherein the step of reacting the soluble phosphorous with a source of magnesium ions occurs in the presence of dissolved oxygen.

4. A process as claimed in claim 1 wherein the amount of soluble phosphorous in the waste water after the step of reacting the soluble phosphorous is less than 5 mg/L.

5. A process as claimed in claim 1 wherein the source of magnesium ions is magnesium oxide.

6. A process as claimed in claim 5 wherein the source of magnesium ions is magnesium oxide granules.

7. A process as claimed in claim 6 wherein the magnesium oxide granules have a granular size in the order of 5 to 20 mm.

8. A process as claimed in claim 6 wherein the process is conducted in a reaction vessel containing a bed of magnesium oxide granules.

9. A process as claimed in claim 5 wherein the source of magnesium ions is magnesium oxide powder.

10. A process as claimed in claim 3 wherein an oxygen containing gas is introduced into the waste water to provide a source of dissolved oxygen.

11. A process as claimed in claim 10 wherein the oxygen containing gas is air.

12. A process as claimed in claim 1 wherein the phosphorous containing precipitate is a magnesium ammonium phosphate precipitate.

13. A process as claimed in claim 1 wherein the precipitate is struvite.

14. A process for treating waste water which contains soluble phosphorous and which comprises a solid component and a liquid component, the process including the step of reacting soluble phosphorous from the solid and liquid components under reaction conditions to form a magnesium ammonium phosphate precipitate.

15. A process for treating waste water which contains soluble phosphorous, the process including the step of reacting soluble phosphorous in the presence of greater than 20 ppm ammonia under reaction conditions to form a magnesium ammonium phosphate precipitate.

16. A treatment plant for treating waste water from a residential property which contains soluble phosphorous and which comprises a solid component and a liquid component, the treatment plant comprising means for reacting soluble phosphorous from the solid and liquid components of the waste water with a source of magnesium ions under reaction conditions to produce a phosphorous containing precipitate.

17. A treatment plant for treating waste water from a residential property which contains soluble phosphorous, the treatment plant comprising means for reacting the soluble phosphorous with a source of magnesium ions in the presence of greater than 20 ppm ammonia under reaction conditions to produce a phosphorous containing precipitate.

18. A treatment plant as claimed in claim 16 wherein the treatment plant is located on or adjacent to the residential property.

19. (canceled)

20. A treatment plant as claimed in claim 17 wherein the treatment plant is located on or adjacent to the residential property.

21. A process as claimed in claim 2 wherein the step of reacting the soluble phosphorous with a source of magnesium ions occurs in the presence of dissolved oxygen.

22. A process as claimed in claim 2 wherein the amount of soluble phosphorous in the waste water after the step of reacting the soluble phosphorous is less than 5 mg/L.

23. A process as claimed in claim 2 wherein the source of magnesium ions is magnesium oxide.

24. A process as claimed in claim 23 wherein the source of magnesium ions is magnesium oxide granules.

25. A process as claimed in claim 24 wherein the magnesium oxide granules have a granular size in the order of 5 to 20 mm.

26. A process as claimed in claim 24 wherein the process is conducted in a reaction vessel containing a bed of magnesium oxide granules.

27. A process as claimed in claim 23 wherein the source of magnesium ions is magnesium oxide powder.

28. A process as claimed in claim 21 wherein an oxygen containing gas is introduced into the waste water to provide a source of dissolved oxygen.

29. A process as claimed in claim 28 wherein the oxygen containing gas is air.

30. A process as claimed in claim 2 wherein the phosphorous containing precipitate is a magnesium ammonium phosphate precipitate.

31. A process as claimed in claim 2 wherein the precipitate is struvite.
